(19) United States
(12) Patent Application Publication
(10) Pub. No.: US 2014/0060175 A1
(43) Pub. Date: Mar. 6, 2014

(54) DUAL FRICTION LOOP FLUID FLOW RESISTANCE MEASUREMENT APPARATUS

(71) Applicants: Nathan R. Hutchings, Shreveport, LA (US); Stewart A. Simpson, Jefferson, TX (US); Eric W. Appleton, (US)

(72) Inventors: Nathan R. Hutchings, Shreveport, LA (US); Stewart A. Simpson, Jefferson, TX (US); Eric W. Appleton, (US)

(21) Appl. No.: 13/604,733

(22) Filed: Sep. 6, 2012

(51) Int. Cl. G01F 7/00

(52) U.S. Cl. 73/196

(57) ABSTRACT

A fluid flow resistance modifying chemical additive system includes a flow loop, a first friction loop flow resistance measuring system coupled proximate an inlet side of the flow loop, at least one chemical additive device downstream of the first friction loop in the flow loop and a second friction loop flow resistance measuring system coupled proximate an outlet side of the flow loop. A method for continuous measuring effect of at least one flow resistance chemical additive on a base fluid include pumping the base fluid into a flow loop. A property of the base fluid is measured. At least one modifying chemical is added to the base fluid. The property of the combined base fluid and at least one flow resistance modifying chemical is then measured and/or modified with respect to the flow resistance properties of the base fluid.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This disclosure relates generally to the field of friction loop/differential pressure gauge apparatus for measuring flow resistance in pipe. More specifically, the disclosure relates to devices for optimizing effectiveness of chemical treatments to reduce fluid flow resistance in pipe.

Fluid flow through pipe may incur resistance thereto by friction between the flowing fluid and the interior surface of the pipe, turbulence in the flowing fluid, and deviations and/or restriction in the flow path, among other factors. Pressure drop resulting from resistance to flow may be determined by the use of a “friction loop.” A friction loop is a conduit that is connected at its ends to an inlet to the pipe and an outlet to the pipe. A differential pressure transducer may be hydraulically or pneumatically connected to the conduit at spaced apart locations along the conduit. The differential pressure transducer may be of a type that does not enable flow therethrough. The measured differential pressure is related to the pressure drop in the pipe and the differential pressure may be calibrated to provide a direct measurement of pressure loss in the pipe due to flow.

It is known in the art to modify the fluid flow characteristics of fluids by adding chemicals such as friction modifiers and viscosity modifiers, among other chemicals. While conventional friction loops may determine whether the chemical additives are effective, in a continuous throughput pumping system it is difficult to determine the relative effectiveness of such additives without information concerning the flow resistance characteristics of the unmodified base fluid. In intermittent pumping applications, particularly those wherein the base fluid composition frequently changes within a single operation or between subsequent operations, including but not limited to oilfield well completion operations, systems known in the art are insufficient to enable the optimization of chemical rheology modifier(s) usage in dynamic flow-through systems. In such circumstances, factors such as dissolved solids, mineral content, suspended solids, and residual rheology modifiers from previous operations all influence the optimum concentration of chemicals required to maintain consistent fluid rheology in a continuous throughput pumping system. Furthermore, these systems tend to have dynamic flow rates which further compound the need for a means to continuously monitor and optimize the rheological properties of the fluid.

There is a need for a measurement device to enable determination of the effectiveness of chemical additives in modifying fluid flow characteristics and to optimize the mixture of chemical additives in reducing resistance to flow of the base fluid in continuous throughput systems, particularly when the base fluid properties dynamically change throughout the pumping procedure.

### SUMMARY

One aspect of the disclosure is a fluid flow resistance modifying chemical additive system including a flow loop, a first friction loop flow resistance measurement system coupled proximate an inlet side of the flow loop, at least one chemical additive device downstream of the first friction loop in the flow loop and a second friction loop flow resistance measurement system coupled proximate an outlet side of the flow loop.

Another aspect of the disclosure is a method for measuring effect of at least one flow resistance chemical additive on a base fluid. Such method includes pumping the base fluid into a flow loop. A property of the base fluid related to resistance to flow thereof is measured. At least one flow resistance modifying chemical is added to the base fluid downstream of a position of the measuring the property of the base fluid. The property of the combined base fluid and at least one flow resistance modifying chemical is then measured.

Other aspects and advantages of the invention will be apparent from the description and claims which follow.

### BRIEF DESCRIPTION OF THE DRAWINGS

FIG. 1 shows an example dual friction loop fluid flow resistance measurement and chemical additive blending system.

### DETAILED DESCRIPTION

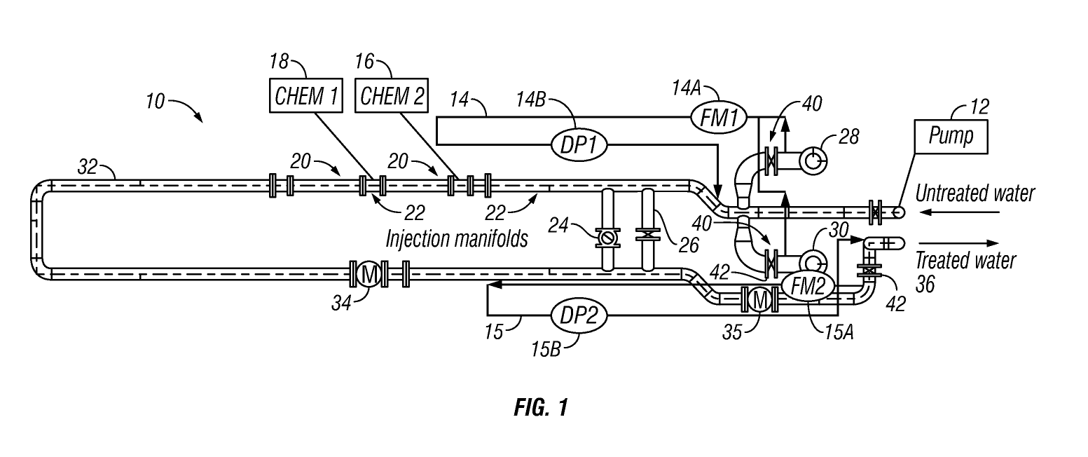

FIG. 1 shows an example chemical additive blending system using a dual friction loop to measure the effect of chemical additives in modifying the flow resistance characteristics of fluid as a result of mixing the additives. A flow loop 32 may accept base fluid, for example, water, therein through either a filter pot, a seat for which is shown at 28, or through another inlet connected to a base fluid pump 12. A first friction loop 14 may be connected between an inlet side of the flow loop 32 and a location downstream of the inlet side of the flow loop 32 with a flow control/restriction valve 40 between the friction loop inlet and outlet points, as shown by arrows pointing thereto at the ends of the first friction loop 14. The first friction loop 14 may include a flowmeter 14A therein to verify that a specific flow rate is achieved through the friction loop such that the pressure loss observed in the first friction loop's 14 differential pressure transducer 14B is comparable to the loss observed in the second friction loop 15. The second friction loop 15 may have a matching differential pressure transducer 15B and flow meter 15A. Downstream of the first friction loop 14 in the flow loop 32 may be disposed injection manifolds 22, wherein chemical additives may be introduced into the flowing base fluid, such as from chemical storage and pumping units shown at 18 and 16. The chemical additives may modify the fluid flow resistance characteristics of the base fluid may include, as non limiting examples, friction modifiers and viscosity modifiers of compositions known in the art. The chemical storage and pumping units shown at 18 and 16 may have controllable discharge rates, the purpose for which will be explained below.

An inline mixer 20 may be included downstream of each injection manifold 20 to facilitate mixing of each chemical additive with the base fluid. Although the example shown in FIG. 1 includes two chemical storage and pumping units, two inline mixers and two injection manifolds, the number of the foregoing elements is not intended to limit the scope of the present disclosure. The disclosure is intended to encompass within its scope any number of such components in a fluid mixing flow loop.

Further downstream of the foregoing components may be disposed a recirculation flow meter 34, which may be used to determine the total amount of fluid flowing through the part of the flow loop downstream of the chemical storage and pumping units 16, 18. A check valve 24 may be included in the flow loop 32 as shown and a bypass valve 26 for cases where no chemical is to be added to the base fluid. The flow loop 32 may include a discharge flow meter 35 to measure the amount of fluid leaving the flow loop 32. The recirculation flow meter 34 and the discharge flow meter 35 should generally measure the same flow rate when the bypass valve 26 is closed.

A second friction loop 15 may be coupled between an outlet side of the flow loop 32 and another point upstream thereof, with a flow control/restriction valve 42 between the friction loop inlet and outlet points . The second friction loop 15 may include a flowmeter 15A and a differential pressure sensor 15B. The second friction loop 15 may measure fluid flow resistance properties of the base fluid after it has been mixed with the chemical(s) as described above. Fluid may be discharged from the flow loop 32 by an exit port as shown at 36.

In using the example flow loop and chemical additive mixing system shown in FIG. 1, flow resistance characteristics of the base fluid may be measured using the first friction loop 14. The flow resistance characteristics of the base fluid as modified by adding chemical(s) as explained above may be measured using the second friction loop 15. If both flow loops 14, 15 have matching physical properties such as: length of total flow path, pipe curvature, distance between differential pressure transducer ports, material composition, etc, the relative differential pressure measurements made by the two friction loops are directly comparable with each other. If the two friction loops do not have matching physical properties, comparisons between the two friction loops can be made by reducing the two differential pressures outputs to common terms using existing pressure loss modeling equations, although this technique is much more difficult to use.

In one example, rate of injection of the chemical(s) may be optimized by adjusting the flow rates from the one or more chemical storage and pumping units shown at 18 and 16 so that the differential pressure measured by the sensor in the second friction loop is minimized relative to the differential pressure measured by the sensor in the first friction loop 14. Such adjustment may be manually performed or automatically performed, if, for example, the differential pressure sensors 14B, 15B and power operated flow controls (not shown) of the chemical storage and pumping units shown at 18 and 16 are connected to a processor such as a programmable logic controller (not shown). Flow resistance optimization may include either optimum reduction in flow resistance of the base fluid or optimum increase thereof, depending on the specific rheological properties desired in the chemically modified fluid.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A fluid flow resistance modifying chemical additive system, comprising:
a flow loop;
a first friction loop flow resistance measuring system coupled proximate an inlet side of the flow loop;
at least one chemical additive device downstream of the first friction loop in the flow loop; and
a second friction loop flow resistance measuring system coupled proximate an outlet side of the flow loop.

2. The system of claim 1 wherein the first and second friction loop flow resistance measuring systems each comprise a flow control valve, a flow meter and a differential pressure sensor.

3. The system of claim 1 wherein the at least one chemical additive device comprises a chemical storage and pump coupled to an injection manifold in the flow loop.

4. The system of claim 3 further comprising at least one inline mixer downstream of the injection manifold in the flow loop.

5. The system of claim 1 further comprising a flow meter disposed proximate the inlet side of the flow loop and a flow meter proximate the outlet side of the flow loop.

6. The system of claim 1 further comprising a bypass valve coupled between the inlet side of the flow loop and the outlet side thereof at a position in the flow loop enabling bypasss of the at least one chemical additive device.

7. A method for measuring effect of at least one flow resistance chemical additive on a base fluid, comprising:
pumping the base fluid into a flow loop;
measuring a property of the base fluid related to resistance to flow thereof;
adding at least one flow resistance modifying chemical to the base fluid downstream of a position of the measuring the property of the base fluid;
measuring the property of the combined base fluid and at least one flow resistance modifying chemical.

8. The method of claim 7 further comprising adjusting an amount of the flow resistance modifying chemical added to the base fluid to optimize a change in resistance to flow thereof.

9. The method of claim 7 further comprising measuring a flow rate of the base fluid into the flow loop and measuring a flow rate of the base fluid and added at least one chemical out of the flow loop.

10. The method of claim 7 further comprising bypassing flow through the flow loop prior to adding the at least one chemical.
